(19) United States
(12) Patent Application Publication
(10) Pub. No.: US 2021/0094057 A1
(43) Pub. Date: Apr. 1, 2021

(54) Adjustable Sprinkler Housing

(71) Applicant: Rain Bird Corporation, Azusa, CA (US)

(72) Inventors: Glade Lamar Hansen, Vail, AZ (US); Daniel Roger St. George, Tucson, AZ (US); Scott Allen Rottler, Vail, AZ (US)

(21) Appl. No.: 16/948,610

(22) Filed: Sep. 24, 2020

Related U.S. Application Data
(60) Provisional application No. 62/907,330, filed on Sep. 27, 2019.

(51) Int. Cl. B05B 15/68; B25B 27/14

(52) U.S. Cl. CPC B05B 15/68; B25B 27/14

(57) ABSTRACT

A sprinkle is provided with an adjustable housing. The housing includes two components that are adjustable relative to one another. One of the housing components supports the sprinkler internals so that the can be raised to ground level.

### CROSS-REFERENCE TO RELATED APPLICATIONS

This application claims benefit of and priority to U.S. Provisional Application No. 62/907,330, filed Sep. 27, 2019.

### FIELD OF THE INVENTION

The subject matter of this application pertains to sprinklers and, more particularly, to adjustment of a sprinkler housing.

### BACKGROUND

Irrigation of turf is commonly done by inground irrigation systems. These systems commonly include pop-up type sprinklers. A pop-up sprinkler includes a riser that extends out of (pops ups from) a housing in order to irrigate and retracts back into the housing between irrigation cycles. The tops of these pop-up sprinklers are installed flush with the ground so that they do not interfere with maintenance, such as lawing mowing equipment.

In order to improve playability on golf courses, it is standard procedure to top dress the grass. This involves applying a thin layer of sand to the grass. Over time, this process raises the level of the ground as much as ¾ inches in a year. As the surface of the ground rises, the sprinklers remain at the same level and can become covered with the sand. This can create an unwanted divot or interference with the operation of the sprinkler. Thus, when this happens, it is best practice for each sprinkler subject to this condition to be excavated and repositioned. This re-elevation process is labor intensive and can be damaging to the turf surrounding the sprinkler. Typically, the re-elevation process includes removing the sod and soil around the sprinkler and the swing joint or connecting pipe, raising the sprinkler, leveling the sprinkler, reinstalling and packing the dirt around the sprinkler and re-laying the sod.

One known solution is to add plates to the top of the sprinkler to create a new top surface at ground level. However, this method does not raise the sprinkler itself and leaves the sprinkler still subject to damage occurring from the sand, and allows the spray from the sprinkler to damage the surrounding ground. Other known solutions involve rotating one of the housings, which can subject control tubes and wires to damage.

Thus, there is a desire for a sprinkler that can be easily re-elevated to save labor costs and eliminate potential for turf damage and that can be done in a manner that does not compromise the effectiveness of the control lines and wires.

### BRIEF DESCRIPTION OF THE DRAWINGS

FIG. 1 is a perspective view of a sprinkler with an adjustable housing;

FIG. 2 is a cross-sectional view of the sprinkler of FIG. 1;

FIG. 3 is a top perspective view of an upper housing of the sprinkler of FIG. 1;

FIG. 4 is a cross-sectional view of the upper housing of FIG. 3;

FIG. 5 is perspective view of a lower housing of the sprinkler of FIG. 1;

FIG. 6 is a cross-sectional view of the upper housing of FIG. 5;

FIG. 7 is a top plan view of the upper housing of FIG. 5;

FIG. 8 is a perspective view of the locking ring of the sprinkler of FIG. 1;

FIG. 9 is a cross-sectional view of the locking ring of FIG. 8;

FIG. 10 is an enlarged partial cross-sectional view of the sprinkler of FIG. 2 without a riser;

FIG. 11 is a perspective view of an elevational tool attached to a sprinkler; and

FIG. 12 is a cross-sectional view of the elevational tool and the sprinkler of FIG. 11.

### DETAILED DESCRIPTION

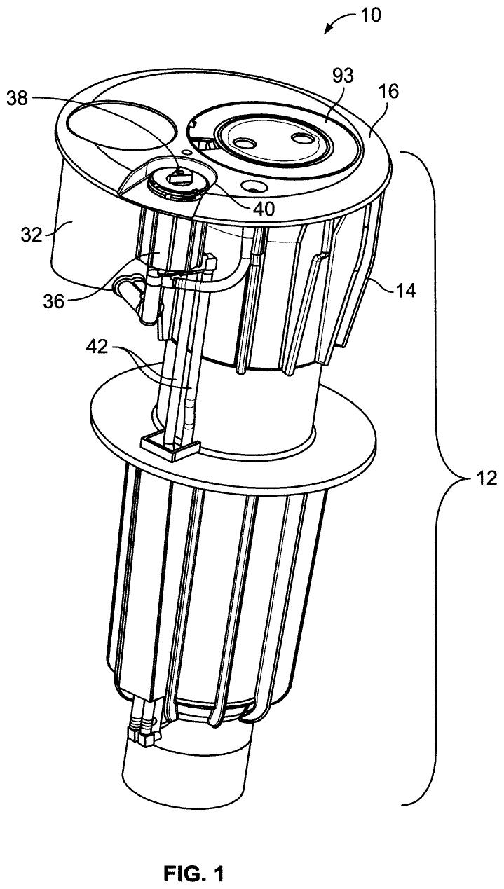

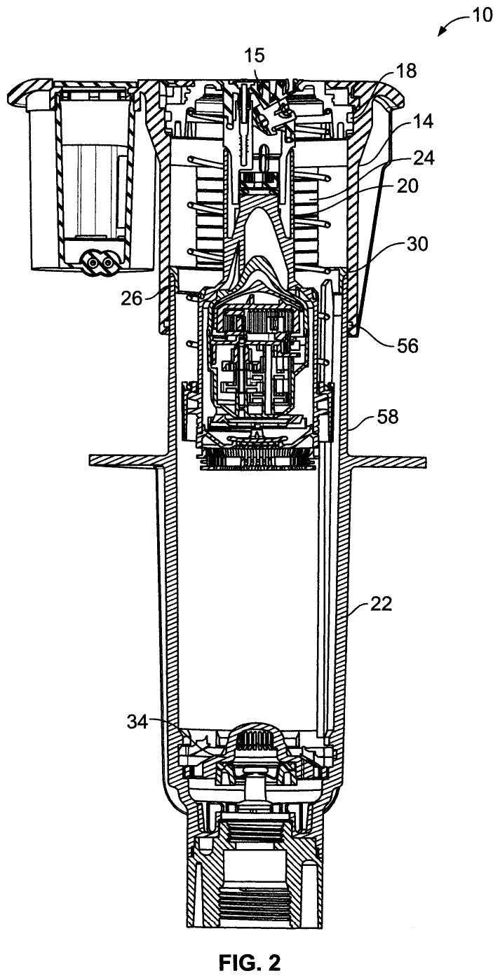

With reference to FIGS. 1 and 2, there is illustrated an exemplary embodiment of a pop-up type sprinkler 10 with an adjustable housing 12. The adjustable housing 12 consists of three components. First, there is an upper housing 14 with a flange 16 that aids to prevent the sprinkler 10 from being pushed further into the ground and to support controls features of the sprinkler 10. The upper housing 14 also provides mounting features 18 for a riser 20 of the sprinkler 10. The riser 20 carries a nozzle 15 for irrigating surround turf when extending (popped up) from the adjustable housing 12. Second, there is a lower housing 22 which attaches to an irrigation system pipe and forms a stable base for the sprinkler 10 in surrounding soil. The lower housing 22 remains stationary throughout the life of the sprinkler 10, while the upper housing 14 is adjustable relative to the lower housing 22 to match the elevation of the surrounding soil, as described further below.

A series of columns of notches 24 disposed longitudinally in an inner surface of the upper housing 14 provide latching points for tabs 26 formed about an upper perimeter of the lower housing 22. More specifically, the tabs 26 nest into the notches 24. This retains the upper housing 14 and the lower housing 22 in position relative to one another. Third, there may be a locking ring 30 that assures that the tabs 26 do not release from the notches 24, particularly during operation of the sprinkler 10 or when an external force, such as a downward force, is applied to the flange 16 of the upper housing 14. The locking ring 30 is removed to facilitate changing of the positioning between the upper and lower housings 14,22 and, then, is reinstalled.

The adjustable housing 12 allows the upper housing 14 along with the riser 20 to be raised with minimal or no damage to the surrounding sod. During adjustment, the tabs 26 are moved to the desired notch 24 that corresponds to the desired height of the flange 16 of the upper housing 14. Thus, this embodiment significantly reduces the amount of time required to adjust the housing 12 because the upper case 14 is lifted straight up. Further, a straight vertical adjustment does not twist wires or other control lines.

The flange 16 of the upper housing 14 supports control components of the sprinkler 10. For instance, there may be a solenoid 32 that opens and closes a main valve 34 in the lower housing 22 that turns the sprinkler 10 on and off. There also may be a pressure regulator and service valve 36. The regulator feature 38 can be set to control the pressure flowing through the housing 12. The service valve feature 40 can be used to manually switch the sprinkler 10 between ON and OFF settings and to set the sprinkler 10 to an AUTO setting that is controlled by a controller executing a watering schedule. Tubes 42 connect the solenoid 32 and the pressure regulator and service valve 36 to the housing 12 and main valve 34. Wires (not shown) may be used to interconnect the solenoid 32 to a controller.

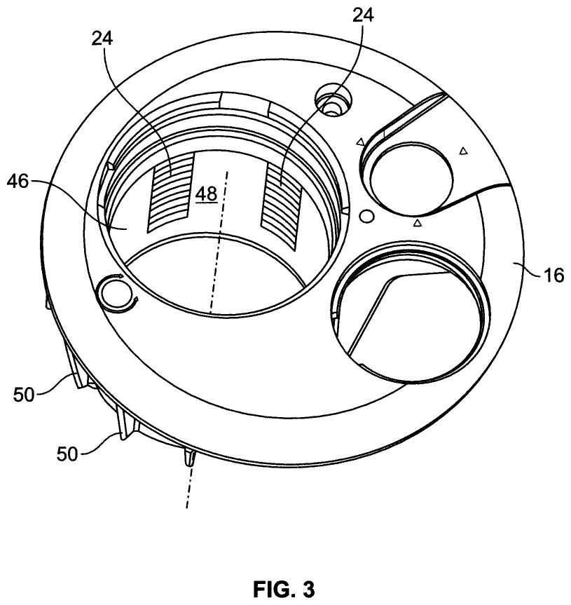

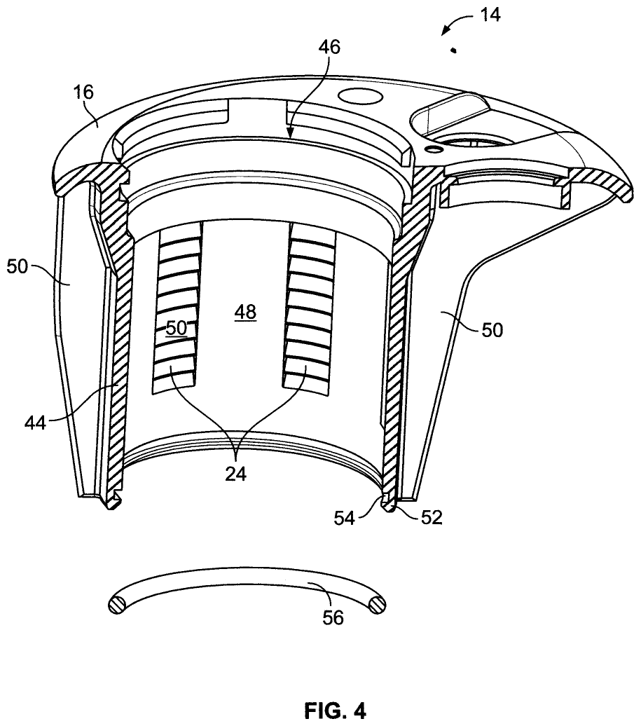

With reference to FIGS. 3 and 4, the upper housing 14 includes a side wall 44 that depends from the flange 16. The side wall 44 defines an inner passage 46 that may be cylindrical in shape. The side wall 44 includes an inner surface 48 that defines columns of the notches 24. For example, there may be six columns of notches 24 equally spaced about the circumference of the inner surface 48. Other number of columns may be used as well. Each notch 24 may be formed by a projection 50 that may be arcuate to match the curvature of the inner surface 48. Each projection 50 may be angled radially inward and downward with the notch 24 located underneath and so that the tabs 26 can cam over the notches 24 as the upper housing 14 is moved away from the lower housing 22 to extend the housing 12.

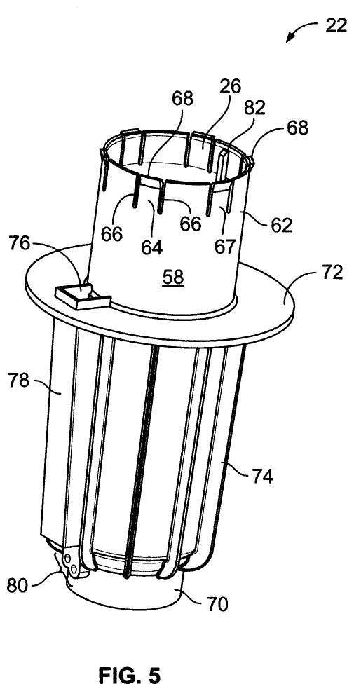

A lower end 52 of the upper housing 14 includes an annular groove 54 that receives an o-ring type seal 56 that engages an outer surface 58 (FIG. 5) of the lower housing 22 to seal the upper and lower housings 14,22 together to prohibit fluid from leaking. The side wall 44 may include radially extending wings 60 that engage soil surrounding the sprinkler 10 to resist movement such as rotational movement of the sprinkler 10 during operation.

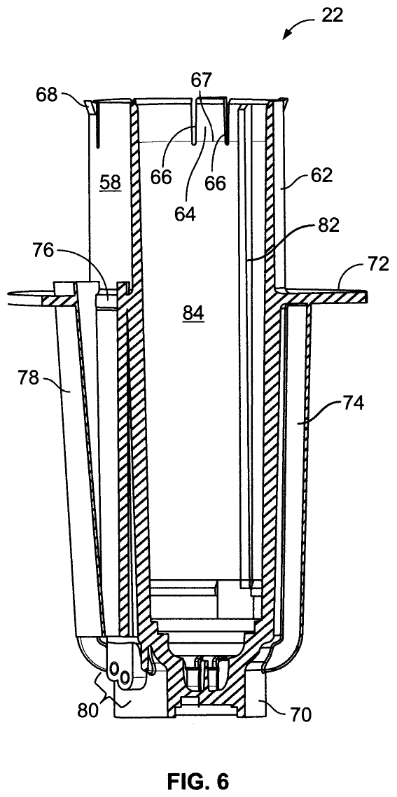

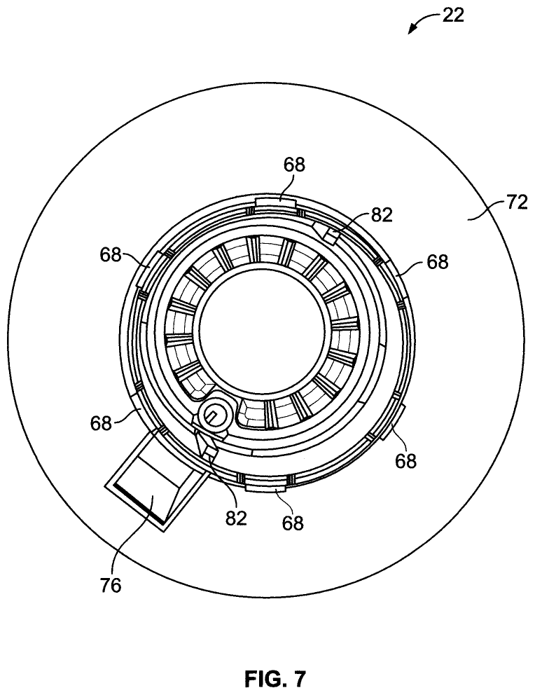

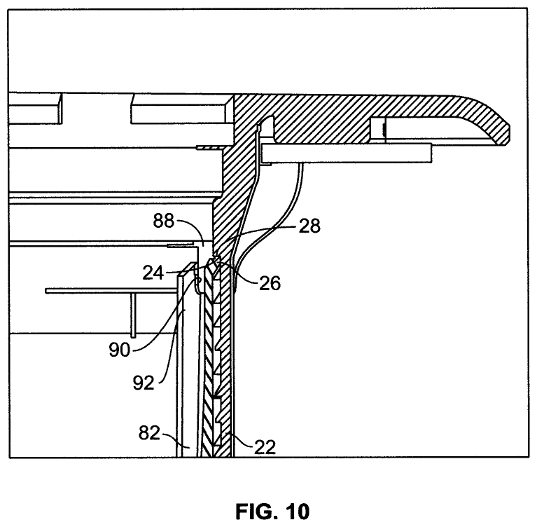

As shown in FIGS. 5-7, the lower housing 22 includes the tabs 26 located at an upper end portion 62. For example, there may be a tab 26 for each column of notches 24. Each tab 26 may include a finger 64 formed by a pair of longitudinal slits 66 to provide the tab 26 with flexibility to move in and out as the tabs 26 move over the notches 24 during adjustment of the upper and lower housings 14,22. The tabs 26 move about a living hinge 67. Each finger 64 terminates with a hook 68 having a generally triangular cross-section (see FIG. 10) that engages in its respective notch 24 to lock the upper and lower housings 14,22 together. The fingers 64 and hooks 68 may be arcuate to match the curvature of the outer surface 58 of the lower housing 22.

A lower end portion 70 includes a connection to attach the housing 12 to a water supply conduit. A second flange 72 may radially extend from the lower housing 22 intermediate the upper end portion 62 and the lower end portion 70. The second flange 72 engages surrounding soil to resist movement of the sprinkler 10 as the upper housing 14 is adjusted relative to the lower housing 22. Additional wings 74 extend radially from the lower housing 22 between the second flange 72 and the lower end portion 70 of the lower housing 22 to further help resist movement such as rotational movement of the sprinkler 10 during operation.

The second flange 72 defines a hole 76 through the second flange 72 for the tubes 42 to pass. This configuration allows the tubes 42 to remain close to the housing 12 and reduces the potential for damage or pinching, particularly by the second flange 72 and the surrounding soil or being hit by a tool used to dig up soil around the sprinkler 10. The hole 76 may lead into a passageway 78 that extends from the second flange 72 to a pair of ports 80 leading into the lower housing 22. While the illustrated passageway 78 has a rectangular cross-section, it may have other cross-sections, such as, for example, triangular and circular.

The lower housing 22 includes a pair of diametrically opposed ribs 82 extending longitudinally along and projecting radially inward from an inner surface 84. The ribs 82 engage the riser 20 to lock the riser 20 against rotational movement relative to the lower housing 22 but allow longitudinal movement of the riser relative to the lower housing 22 during operation of the sprinkler 10.

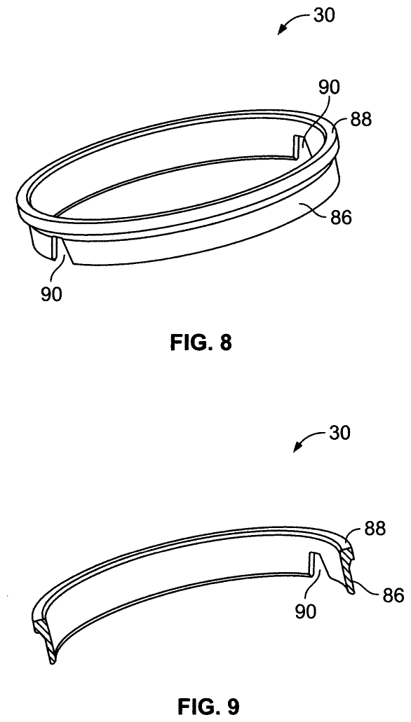

With reference to FIGS. 8-10, there is illustrated the locking ring 30. The locking ring 30 sits, in part, inside the upper perimeter 28 of the lower housing 22 to prevent the tabs 26 from moving inward radially and out of the notches 24. The locking ring 30 includes an axially extending portion 86 and a radially extending portion 88. The axially extending portion 86 engages the tabs 26, and the radially extending portion 88 sits on top of the tabs 26 and prevents further insertion of the locking ring 30 into the lower housing 22. The ring 30 includes a pair of notches 90 so that the locking ring 30 can receive a top portion 92 of the ribs 82. The notches 90 straddle the top portion of the ribs 82 to enable the locking ring 30 to extend into the locking housing 22 to engage the tabs 26.

To raise the upper housing 14, one can simply pull up on the flange 16 of the upper housing 14. This vertical movement does not affect the controls such as the tubes 42 or wires connected to the solenoid 32. For example, there is no rotational movement required which would twist the tubes and wires. Twisting of these control lines could cause them to be kinked or severed or come loose.

However, if a locking ring 30 is being used, one will first need to remove the locking ring 30. To obtain access to the locking ring 30, the riser 20 will need to be removed. The riser 20 is held in place by a snap ring 93 (FIG. 1). The snap ring 93 is manipulated so that its free ends are moved closer and is then pried from the upper housing 14. Once the snap ring 93 is removed, the riser 20 is pulled from the housing 12. Then one can remove the locking ring 30 and move the upper housing 14 away from the lower housing 22. After adjusting the upper housing 14, the riser 20 and snap ring 93 are reinstalled.

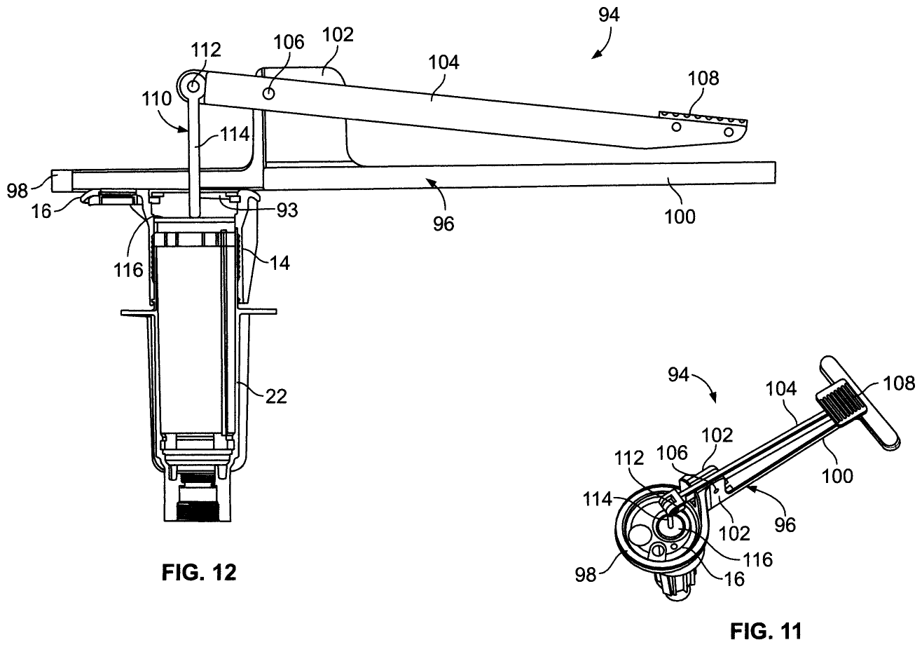

Referring to FIGS. 11 and 12, there is illustrated an elevational tool 94 for raising the upper housing 14 relative to the lower housing 22. The elevational tool 94 includes a base 96 with a circular portion 98 through which the flange 16 of the upper housing 14 can be pulled through and a T-shaped portion 100 that provides further support on the ground. A pivot structure 102 consisting of two walls extends perpendicularly from the T-shaped portion 100. A lever 104 is attached at the pivot structure 102 with a pin 106. The lever 104 includes a foot or hand pad 108 at one end for operating the lever 104 and is attached to a plunger 110 at the other end with another pivot pin 112. The plunger 110 includes a shaft 114 that can extend into the upper housing 14 and an enlarged head 116 at its terminal end that can be locked into the upper housing 14 with the snap ring 93.

The dimensions of the components of the elevational tool can be set so that the amount the lever 104 can be pressed down to the T-shaped portion 100 of the base 96 will automatically bring the flange 16 to ground level. For example, the following dimensions could be used: the length of the shaft 114 could be 4.854 inches, the distance from the pin 106 to the pin 112 could be 3.5 inches, the distance from pin 106 to the pad 108 of the lever 104 could be 17.830 inches, and the height of the pin 106 on the pivot structure 102 from the ground could be 4.379 inches. These dimensions could be changed proportionally and still maintain the same adjustment function so that movement of the lever down to the base provides the desired adjustment of the flange 16 to ground level.

To use the elevational tool, one first removes the snap ring 93, the riser 20 and locking ring 30 (if used), as described above. Then, one inserts a portion of the shaft 114 and the enlarged head 116 into the upper housing 14 and presses down on the pad 108 of the lever 104 to raise the flange 16 of the upper housing 14 level with the surrounding sod. After raising the flange 16 the appropriate amount, the elevational tool 94 is detached from the sprinkler 10 by first removing the snap ring 93 and then extracting the enlarged head 116 and the shaft 114. Next, the riser 20 and the snap ring 93 are reinstalled.

The matter set forth in the foregoing description and accompanying drawings is offered by way of illustration only and not as a limitation. While particular embodiments have been shown and described, it will be apparent to those skilled in the art that additional and modifications may be made without departing from the broader aspects of the technological contribution. The actual scope of the protection sought is intended to be defined in the following claims.

What is claimed is:

1. An adjustable sprinkler housing comprising:
a first housing having a plurality of notches arranged longitudinally along the first housing;
a second housing having at least one tab, the tab having a longitudinally extending finger that flexes about a living hinge; and
wherein the at least one tab engages at least one of the plurality of notches to secure the first and second housings against movement relative to one another and the at least one tab moves about the living hinge to disengage from the at least one of the plurality of notches such that the first and second housings are capable of moving longitudinally relative to one another.

2. The adjustable sprinkler of claim 1 further comprising a lock insert being insertable into the one of the first and second housings to hold the at least one tab in the at least one of the plurality of notches.

3. The adjustable sprinkler of claim 1 wherein the lock insert is insertable into the second housing and seats against the finger of the at least one tab.

4. The adjustable sprinkler of claim 3 wherein the lock insert is a ring.

5. The adjustable sprinkler of claim 1 wherein the lock insert includes a stop that limits insertion into one of the first and second housings.

6. The adjustable sprinkler of claim 1 wherein the at least one tab includes a top surface that extends radially outward and downstream.

7. The adjustable sprinkler of claim 6 wherein at least one of the plurality of notches angles radially outward and downstream to receive the at least one tab.

8. The adjustable sprinkler of claim 1 wherein the second housing includes a radially extending flange.

9. The adjustable sprinkler of claim 1 wherein the second housing includes an upstream end and a downstream end and the flange is located intermediate the upstream and downstream ends.

10. The adjustable sprinkler of claim 1 wherein the flange defines a hole.

11. The adjustable sprinkler of claim 10 wherein the second housing includes a passage aligned with the hole.

12. A tool for raising at least a portion of a sprinkler comprising:
a base to be set at ground level;
a lever pivotally connected to the base, the lever having a first end to be moved to raise at least a portion of a sprinkler and second end opposite the first end;
an attachment shaft attached to the second end of the base to attach to at least a portion of a sprinkler.

13. The tool of claim 12 further wherein the attachment shaft is connected to the second end of the lever.

14. The tool of claim 12 wherein the shaft includes an enlarged head that connects to at least a portion of a sprinkler.

15. A method for raising at least a portion of a sprinkler comprising:
providing a sprinkler with a first housing having a plurality of notches arranged longitudinally along the first housing, a second housing having at least one tab, the tab having a longitudinally extending finger that flexes about a living hinge, and wherein the at least one tab engages at least one of the plurality of notches to secure the first and second housings against movement relative to one another;
moving one of the first and second housings such that the at least one tab moves about the living hinge to disengage from the at least one of the plurality of notches; and
reseating the at least one tab in another of the at least one of the plurality of notches.

16. The method of claim 15 further providing a lock insert, inserting the lock insert into the one of the first and second housings and seating the lock insert against the at least one tab.

17. The method of claim 15 further providing a tool having a base to be set at ground level, a lever pivotally connected to the base, the lever having a first end to be moved to raise at least a portion of a sprinkler and second end opposite the first end, and an attachment shaft attached to the second end of the base to attach to at least a portion of a sprinkler, attaching the attachment shaft to at least one of the first and second housings, and activating the lever to move at least one of the first and second housings relative to the other.

18. The method of claim 15 further comprising detaching the attachment shaft from the at least one of the first and second housings.
